(19) United States
(12) Patent Application Publication
(10) Pub. No.: US 2018/0112789 A1
(43) Pub. Date: Apr. 26, 2018

(54) Volume Flow-Regulated Seat Valve

(71) Applicant: KENDRION (Villingen) GmbH, Villingen-Schwenningen (DE)

(72) Inventors: Wolfram Maiwald, Obereschach (DE); Stefan Barth, Donaueschingen (DE); Florian Schulz, Brigachtal (DE)

(21) Appl. No.: 15/568,853

(22) PCT Filed: Jun. 8, 2016
(86) PCT No.: PCT/EP2016/063039

§ 371 Date: Oct. 24, 2017

(30) Foreign Application Priority Data
Jun. 9, 2015 (DE) 10 2015 109 077.5

(51) Int. Cl. F16K 27/02; F16K 1/12; F16K 31/06; F01N 3/20; F02M 59/36; F02M 59/44; F02M 63/00

(52) U.S. Cl. CPC F16K 27/0245; F16K 1/123; F16K 31/0665; F01N 3/2066; F01N 2610/1453; F02M 59/445; F02M 63/0036; F01N 2610/02; F02M 59/367

(57) ABSTRACT

The invention is a volume control valve for controlling and metering a fluid in a motor vehicle, comprising a tappet with an actuating end and a free end, said tappet being received in a bearing bush and mounted along its actuating axis so as to be movable back and forth, and a seat valve which is connected to a fluid channel and arranged relative to the tappet in such a way that the free end of the tappet can engage in the valve seat and close the fluid channel when it is engaged in said valve seat, and further comprising a pressure spring which is arranged along the longitudinal axis of the tappet. According to the invention, a welded plate is fastened and/or welded and/or formed on the tappet with the pressure spring arranged thereon, which is supported on the welded plate and the bearing bush.

### CROSS REFERENCE TO RELATED APPLICATIONS

This patent application claims priority to International Patent Application PCT/EP2016/063039, filed on Jun. 8, 2016, and to German Patent Application 10 2015 109 077.5, filed on Jun. 9, 2015.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention relates to a volume flow-regulated seat valve.

### Background of the Invention

The present invention relates to a volume control valve to control and/or dose a fluid in a motor vehicle according to the preamble of claim 1, a motor vehicle comprising a volume control valve, which controls the fuel supply, as well as a diesel-operated motor vehicle comprising a volume control valve, which doses a reduction means.

Volume control valves in motor vehicles serve for the simple control of the pump pressure, for example in common rail systems, as used in modern mass-produced motor vehicles, for example for controlling the volume flow in high-pressure pumps. In such systems the fuel is provided highly pressurized in a high-pressure reservoir and then injected via a common line into the respective cylinders. One injector is provided here for each cylinder, which injects the fuel in the opened state. Such volume control valves may be embodied as seat valves. Seat valves are for example known from DE 198 10 241 A1, DE 103 08 482 A1, DE 44 30 509 A1, or DE 10 2004 057 873 A1. The seat valve shown in DE 10 2004 057 873 A1 is particularly suited for an embodiment, which when no power is supplied is embodied in a closed fashion independent from any pressure, and is preferably used in high-pressure applications.

Seat valves of prior art, which are closed in the default state, show in addition to the advantages of a quick response a large channel cross-section, which ensures high flowrates, however they are disadvantageous in that due to the pressure applied upon the valve seat here strong springs are required in order to keep the valve closed. This leads to very high minimal operating pressures, which are required to generate any flow. In order to control the flow frequently at first a strong force must be applied, which then needs to be finely adjusted. This aggravates the possibility of precise dosing. Another disadvantage of these seat valves of prior art is their relatively complicated design. For example, in many embodiments a counter-anchor presses via a spring element upon an anchor, with the front end of the tappet pressing upon the valve seat in order to block the flow of the fluid.

The objective of the present invention is therefore to provide a volume control valve which is open in the default state, which allows the precise dosing of fluid, a precisely adjustable flow of the fluid through the valve, and which may be designed in a simple, compact fashion and is free from wear and tear.

This objective is attained in a volume control valve to control and/or dose a fluid in a motor vehicle, a motor vehicle comprising such a volume control valve, which controls the fuel supply of the motor vehicle, as well as the use of such a volume control valve to dose a reduction means of a diesel-operated motor vehicle, all as fully described herein.

### BRIEF SUMMARY OF THE INVENTION

In a preferred embodiment, a volume control valve (1) for controlling and/or dosing a fluid in a motor vehicle, comprising
a tappet (18) with an actuating end (24) and a free end (22), which is accepted in a bearing bush (32) in a mobile fashion back and forth along its longitudinal axis,
a valve seat (20) connected to a fluid channel (26), which is arranged in reference to the tappet (18) such that the free end (22) of the tappet (18) can engage the valve seat (20) and close the fluid channel (26) when it engages the valve seat (20),
a pressure spring (30) which is arranged along the longitudinal axis of the tappet (18), characterized in that a welded plate (34) is arranged and/or welded to and/or embodied at the tappet (18), and the pressure spring (30) is arranged between the welded plate (34) and the bearing bush (32), with it being supported at the welded plate (34) and the bearing bush (32).

In another preferred embodiment, the volume control valve (1) as described herein, characterized in that the pressure spring (30) is a coil spring arranged about the tappet (18).

In another preferred embodiment, the volume control valve (1) as described herein, characterized in that in that the bearing bush (32) is arranged between the free end (22) of the tappet (18) and the welded plate (34).

In another preferred embodiment, the volume control valve (1) as described herein, wherein the free end (22) of the tappet (18) is embodied in a spherical or hemispherical fashion.

In another preferred embodiment, the volume control valve (1) as described herein, comprising an anchor (6) that can be magnetized and an electromagnetic coil (4) arranged about the anchor (6), characterized in that the anchor (6) is arranged in reference to the tappet (18) such that it applies pressure upon the actuating end (24) of the tappet (18) and can move the tappet (18) along its longitudinal axis when the coil (4) is electrified.

In another preferred embodiment, the volume control valve (1) as described herein, characterized in that the anchor (6) is guided in an anchor guide tube (8), with its longitudinal axis preferably being parallel to the longitudinal axis of the tappet (18).

In another preferred embodiment, the volume control valve (1) as described herein, characterized in that the tappet (18) is fastened at the anchor (6) or embodied in one piece with it.

In another preferred embodiment, the volume control valve (1) as described herein, characterized in that the free end (22) of the tappet (18) comprises a material which is harder than the material the valve seat (20) is made from, or shows a coating which is harder than the material forming the valve seat (20), with the valve seat (20) preferably being made from machining steel, particularly of the type 11SMn30.

In another preferred embodiment, the volume control valve (1) as described herein, characterized in that the tappet (18) is surrounded by a valve tube (16) between the valve seat (20) and its actuating end (24), which is embodied to allow a fluid passing through it and comprises at least one additional fluid aperture (28) which is embodied as a lateral aperture of the valve tube (16).

In another preferred embodiment, the volume control valve (1) as described herein, characterized in that another bearing bush (36) is arranged between the welded plate (34) and the actuating end (24) of the tappet (18), in which the tappet (18) is accepted in a mobile fashion back and forth along its longitudinal axis.

In a preferred embodiment, a motor vehicle comprising the volume control valve (1) as described herein, with controls the fuel supply to the motor vehicle, with the motor vehicle preferably being a motor vehicle operated with diesel fuel and the volume control valve (1) preferably controlling the fuel supply to a high-pressure pump arranged in the motor vehicle.

In a preferred embodiment, the use of the volume control valve (1) as described herein for dosing reduction means, particularly dosing an aqueous urea solution in an exhaust post-treatment system of the motor vehicle operated with diesel fuel.

### BRIEF DESCRIPTION OF THE DRAWINGS

FIG. 1 is a line drawing evidencing a first exemplary embodiment of a volume control valve according to the invention, which is open in the default state.

FIG. 2 is a line drawing evidencing a second exemplary embodiment of a volume control valve according to the invention.

### DETAILED DESCRIPTION OF THE INVENTION

The volume control valve, which is also called volume flow-regulated seat valve, for controlling and/or dosing a fluid in a motor vehicle comprises a tappet with an actuating end and a free end, which is accepted supported along its longitudinal axis so as to be movable back and forth in a bearing bush, a valve seat connected to the fluid channel, which is arranged in reference to the tappet such that the free end of the tappet may engage the valve seat and closes the fluid channel when it engages the valve seat, as well as a pressure spring, which is arranged along the longitudinal axis of the tappet. According to the invention a welded plate is fastened and/or welded and/or formed at the tappet, and the pressure spring is arranged between the welded plate and the bearing bush, with the pressure spring being supported on the welded plate and the bearing bush.

Such an arrangement simplifies the design of such a volume control valve, because here a counter anchor coupled to a spring may be waived. Furthermore, such a system shows the advantage that particularly when lubricating fluids are guided through the valve lines, for example diesel fuel, simultaneously lubrication occurs of the mechanics of the valve system, which leads to a wear and tear-free valve design.

The welded plate is here fastened and/or welded to and/or embodied at the tappet such that the pressure spring supported between the welded plate and the bearing bush may move the tappet first in the direction of the valve seat, when a minimum pressure, with its value being greater than a certain value above zero, is applied upon the tappet. The minimum pressure is here of such intensity that the pressure spring operates in a linear range, i.e. that the pressure change, as soon as the pressure force exceeds the minimum pressure, is proportional to the displacement of the tappet. This way, oscillating changes of the flow may be damped, which occur for example when the flowrate or the temperature of the fluid changes, or transient motions of the tappet develop through a pulse transmitted by the anchor upon the tappet, since the tappet may not follow these motions.

The pressure spring is preferably embodied as a coil spring arranged about the tappet.

When the bearing bush is arranged at the free end of the tappet and the welded plate, this way a volume control valve is formed which is open in the default state and may be moved in the direction towards the valve bush by a sufficiently strong force applied upon the actuating end of the tappet.

However, if a volume control valve shall be provided which is closed in the default state, the bearing bush at which the pressure spring is supported, is fastened and/or arranged advantageously between the actuating end of the tappet and the welded plate. In this case a volume control valve may be provided, which impinges the valve seat with a minimum pressure force, determined by the pressure spring, and greater than zero, when the volume control valve is not actuated. In this case, with a tensile force engaging the actuating end of the tappet essentially in the direction of the longitudinal axis of the tappet and greater than the minimum pressure, by which the spring pushes the tappet upon the valve seat, the tappet may be moved away from the valve seat and, depending on the distance of motion away from the valve seat, the flowrate through the valve may be controlled.

The free end of the tappet is embodied preferably in a spherical or hemispherical fashion or embodied only partially spherically in the proximity of the seal seat. The spherical or hemispherical embodiment may be particularly a thickening of the tappet. The free end of the tappet is preferably embodied in one piece with the tappet. A spherical or hemispherical free end is advantageous in that no edges or corners are present at the tappet end, which might lead to turbulent eddying of the fluid passing through and this way may trigger resonance effects in the fluid conducted. Another advantage of a spherical tappet end is the fact that here a fine adjustment and fine control of the flowrate may occur when the tappet end is in the proximity of the valve seat. For this purpose, the valve seat is usually embodied concavely, as a receptacle, frequently showing a V-shape, funnel-shape or bowl-shape, and is this way matching the tappet end.

In a variant of the invention it is provided that the tappet or at least the tappet end or the valve element closing the valve seat is formed from a material which is harder than the valve seat itself. For example, the valve element or the front end of the tappet may be made from stainless steel, while the valve seat itself comprises so-called machining steel. During the assembly of such a seat valve the valve element is pushed against the softer valve seat such that here an optimal impression is formed for the valve element. In this context it is also advantageous that the bearing bush leaves some play for the tappet, for example a slight tipping motion of +/−15°. It has shown that here the valve element may optimally impress the valve seat.

The volume control valve preferably comprises an anchor that may be magnetized and an electromagnetic coil arranged around the anchor, with the anchor being arranged in reference to the tappet such that it presses upon the actuating end of the tappet and may move the tappet along its longitudinal axis when the coil is electrified. This way an electromagnetically controlled valve and/or a magnetic valve may be realized.

The tappet may here be embodied in one piece with the anchor, for example. Anchor and tappet may however also be embodied in several pieces. If the anchor and the tappet are embodied in one piece, here a slight tension may be applied at the operating end of the tappet which moves the tappet away from the valve seat. If the anchor and the tappet are embodied as several parts, a modular design is possible for the volume control valve in which the valve may be easily assembled to the matching magnetic unit. Of course, the volume valve may also be operated mechanically or hydraulically. If the volume control valve is a magnetic valve, the anchor is preferably guided in an anchor guide tube, with the longitudinal axis of the anchor guide tube being preferably essentially parallel or identical to the longitudinal axis of the tappet. The tappet may also be fastened via fastening means to the anchor.

The free end of the tappet preferably comprises a material which is harder than the material the valve seat is made from. It may show a coating which is harder than the material which the valve seat is made from. The valve seat is preferably made from machining steel, for example of the type 11SMn30. The free end of the tappet may be made for example from annealed steel of the type 100CR6.

If the fluid influx occurs not from the front, for example, thus not from the free facial area of the volume control valve, but from the side, here soft material combinations are also possible. For example, in this case the tappet or at least the front end of the tappet may be made from a chromium-nickel steel of the material type 1.4301, while the valve seat may comprise machining steel.

The tappet is advantageously surrounded by a valve tube between the valve seat and its actuating end, embodied for fluid passing through it and showing at least one additional fluid aperture, which is formed as a lateral aperture of the valve tube. This way, for example from the front side of the volume control valve a fluid may flow in, which then may flow out through the lateral apertures of the valve tube or vice versa.

In order to ensure safe support of the tappet, here another bearing bush is arranged between the welded plate and the actuating end of the tappet, in which the tappet is supported in a manner as to be movable back and forth along its longitudinal axis.

Volume control valves of the above-described type control in motor vehicles frequently the fuel supply of the motor vehicle, with the motor vehicle for example representing a vehicle operated with diesel fuel, in which the volume control valve for example controls the fuel supply to a high-pressure pump arranged in the motor vehicle.

A volume control valve of the type described above, which is open in the default state or in the state without current flowing, may however also be used for dosing a reduction means, for example, in particular in order to dose an aqueous urea solution for the exhaust post-treatment system of a motor vehicle operated with diesel fuel.

### DETAILED DESCRIPTION OF THE FIGURES

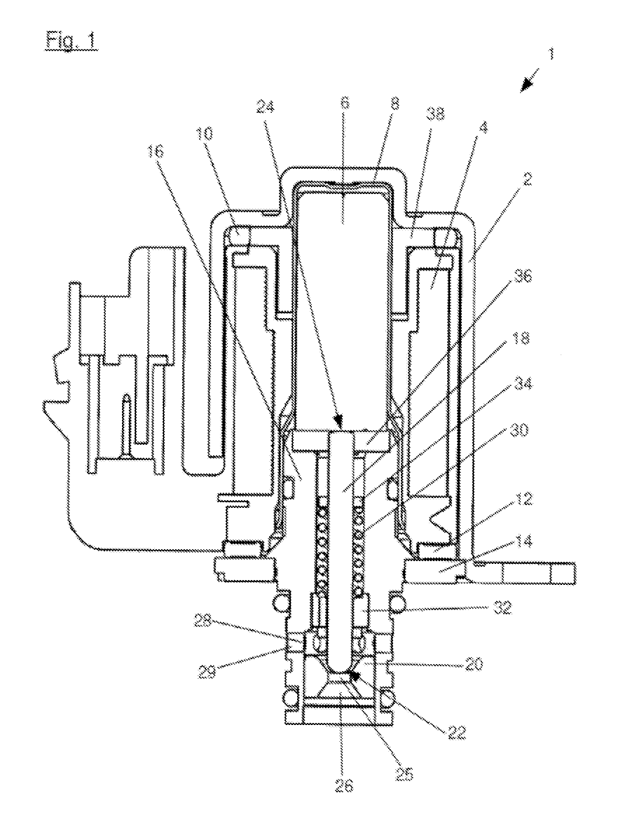

FIG. 1 shows a volume control valve 1 arranged in a casing 2. Furthermore, a coil 4 and an anchor 6, arranged in a mobile fashion in coil 4, are located in casing 2, which anchor is mobile back and forth in an anchor guiding tube and together with coil 4 forms a magnetically operated unit 4, 6, which is fastened between an O-ring 10 and a gasket 12 in casing 2. Gasket 12 is arranged between coil 4 and an annular plate 14 arranged at casing 2 and together with O-ring 10 it seals magnetically operated unit 4, 6 towards the outside.

A valve tube 16 is guided through annular plate 14, which surrounds a tappet 18 and a valve seat 20. Tappet 18 shows a free end 22 and an actuating end 24. Free end 22 of the tappet is embodied in a hemispherical or rounded fashion and may be accepted in valve seat 20 in order to close a fluid aperture 25. Fluid aperture 25 is arranged in valve seat 20, embodied in the present case like a funnel, and forms the end of a fluid channel 26, through which a fluid may be transported, for example a fuel mixture. The front part of valve tube 16 facing fluid aperture 25 comprises another fluid aperture 28, which is arranged laterally at valve tube 16 and is connected to another fluid channel 29. When free end 22 of tappet 18 is accepted in valve seat 20, the flow of the fluid is interrupted between aperture 25 and additional fluid aperture 28. When free end 22 of tappet 18 is arranged at a distance from valve seat 20, here a fluid may flow for example from valve opening 20 via additional valve aperture 28 to additional fluid channel 29, or the fluid may flow from fluid channel 29 via fluid aperture 25 into fluid channel 26.

The flowrate per time unit is here determined by the distance of free end 22 of tappet 18, embodied in the present case in a rounded fashion, from valve seat 20. A pressure spring 30 is arranged around tappet 18 along its longitudinal axis, which extends between a bearing bush 32 and a welded plate 34 which is welded to tappet 18 and is supported both at welded plate 34 as well as bearing bush 32. Tappet 18 is guided through another bearing bush 36, which is fastened at valve tube 16, so that its actuating end 24 may be operated by anchor 6 of the electromagnet 4, 6.

If electromagnetic coil 4 is not electrified, volume valve 1 is open, because pressure spring 30 supported on welded plate 34 welded to tappet 18 and bearing bush 32 holds tappet 18 at a distance from valve seat 20. When coil 4 is electrified with a suitable direction of flow, anchor 6 initially moves in the direction to fluid aperture 25, until it impinges the actuating end 24 of tappet 18. When the current flowing through coil 4 is increased, anchor 6 presses with increasing force upon the actuating end of tappet 18. If this pressure is higher than the force by which tappet 18 is supported at bearing bush 32 fixed at valve tube 16, pressure spring 30 is compressed and tappet 18 is moved in the direction of valve seat 20. This way the flowrate between fluid opening 25 and additional fluid aperture 28 is reduced. This way, the flowrate of fluid through fluid channels 26, 29 may be controlled via the amperage through electromagnetic coil 4.

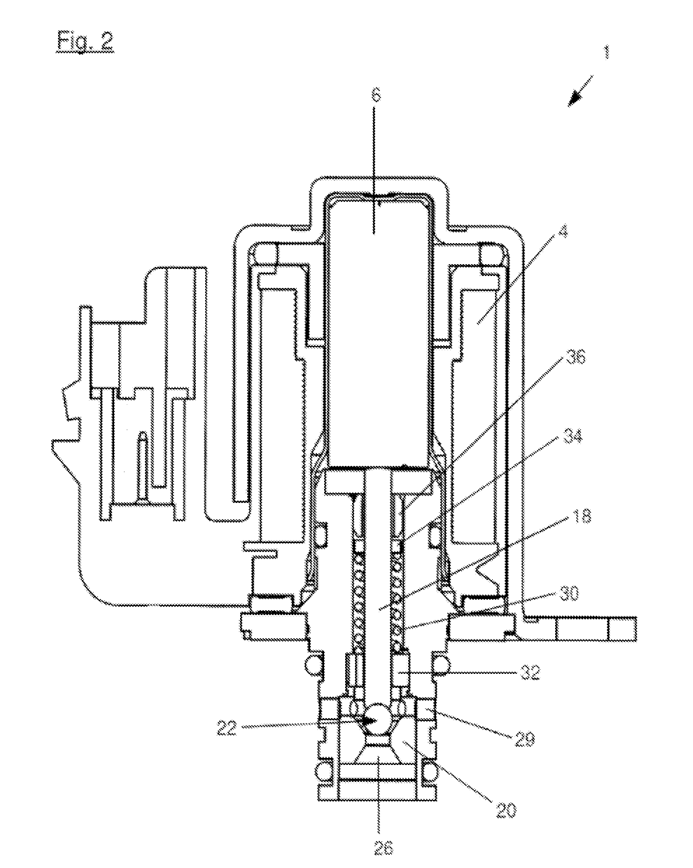

FIG. 2 shows another exemplary embodiment of volume control valve 1 according to the invention, which differs from the first exemplary embodiment only in that tappet 18 is embodied in two parts, with the second part representing free end 22 of tappet 18, which in the present case is embodied as a sphere. When volume control valve 1 is closed, free end 22 of tappet 18, embodied as a sphere, presses upon V-shaped or funnel-shaped valve seat 20 and interrupts the flow between fluid channel 26 and additional fluid channel 29. Similarly, as in the exemplary embodiment of FIG. 1, in the present exemplary embodiment the anchor guide tube 8 is accepted in a sintered tube 38 arranged at casing 2.

### LIST OF REFERENCE NUMBERS

1 volume control valve
2 casing
4 electromagnetic coil
6 anchor that may be magnetized
8 Anchor guide tube
10 O-ring
12 gasket
14 plate
16 valve tube
18 tappet
20 valve seat
22 free end
24 actuating end
25 fluid aperture
26 fluid channel
28 additional fluid aperture
29 additional fluid channel
30 pressure spring
32 bearing bush
34 welded plate
36 additional bearing bush
38 sintered tube

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A volume control valve for controlling and/or dosing a fluid in a motor vehicle, comprising
a tappet with an actuating end and a free end, which is accepted in a bearing bush in a mobile fashion back and forth along its longitudinal axis,
a valve seat connected to a fluid channel, which is arranged in reference to the tappet such that the free end of the tappet can engage the valve seat and close the fluid channel when it engages the valve seat,
a pressure spring which is arranged along the longitudinal axis of the tappet,
wherein a welded plate is arranged and/or welded to and/or embodied at the tappet, and the pressure spring is arranged between the welded plate and the bearing bush, with it being supported at the welded plate and the bearing bush.

2. The volume control valve according to claim 1, wherein the pressure spring is a coil spring arranged about the tappet.

3. The volume control valve according to claim 1, wherein the bearing bush is arranged between the free end of the tappet and the welded plate.

4. The volume control valve according to claim 1, wherein the free end of the tappet is embodied in a spherical or hemispherical fashion.

5. The volume control valve according to claim 1, comprising an anchor that can be magnetized and an electromagnetic coil arranged about the anchor, wherein the anchor is arranged in reference to the tappet such that it applies pressure upon the actuating end of the tappet and can move the tappet along its longitudinal axis when the coil is electrified.

6. The volume control valve according to claim 5, wherein the anchor is guided in an anchor guide tube, with its longitudinal axis being parallel to the longitudinal axis of the tappet.

7. The volume control valve according to claim 5, wherein the tappet is fastened at the anchor or embodied in one piece with it.

8. The volume control valve according to claim 1, wherein the free end of the tappet comprises a material which is harder than the material the valve seat is made from, or shows a coating which is harder than the material forming the valve seat, with the valve seat preferably being made from machining steel, particularly of the type 11SMn30.

9. The volume control valve according to claim 1, wherein the tappet is surrounded by a valve tube between the valve seat and its actuating end, which is embodied to allow a fluid passing through it and comprises at least one additional fluid aperture which is embodied as a lateral aperture of the valve tube.

10. The volume control valve according to claim 1, further comprising wherein another bearing bush is arranged between the welded plate and the actuating end of the tappet, in which the tappet is accepted in a mobile fashion back and forth along its longitudinal axis.

11. A motor vehicle comprising the volume control valve according to claim 1, with controls the fuel supply to the motor vehicle, with the motor vehicle being a motor vehicle operated with diesel fuel and the volume control valve controlling the fuel supply to a high-pressure pump arranged in the motor vehicle.

12. The use of the volume control valve according to claim 1 for dosing reduction means, particularly dosing an aqueous urea solution in an exhaust post-treatment system of the motor vehicle operated with diesel fuel.
